(19) United States
(12) Patent Application Publication
(10) Pub. No.: US 2010/0315632 A1
(43) Pub. Date: Dec. 16, 2010

(54) OPTICAL APPARATUS FOR COMBINED HIGH WAVENUMBER RAMAN SPECTROSCOPY AND SPECTRAL DOMAIN OPTICAL COHERENCE TOMOGRAPHY

(75) Inventor: James F. Brennan, III, Matthews, NC (US)

Correspondence Address: PATTON BOGGS LLP, 8484 WESTPARK DRIVE, SUITE 900, MCLEAN, VA, 22102, US

(73) Assignee: Prescient Medical, Inc., Doylestown, PA (US)

(21) Appl. No.: 12/813,262

(22) Filed: Jun. 10, 2010

Related U.S. Application Data
(60) Provisional application No. 61/185,836, filed on Jun. 10, 2009.

(51) Int. Cl. G01J 3/44; G01J 3/45

(52) U.S. Cl. 356/301; 356/451

(57) ABSTRACT

The present invention provides apparatuses and methods for sample analysis, such as tissue analysis, that integrate high wavenumber (HW) Raman spectroscopy for chemical composition analysis and spectral-domain optical coherence tomography (SD-OCT) to provide depth and morphological information. Intravascular catheter embodiments and related vascular diagnostic methods are also provided.

### CROSS-REFERENCE TO RELATED APPLICATIONS

This application claims the benefit of U.S. provisional patent application Ser. No. 61/185,836 filed Jun. 10, 2009, which is incorporated by reference herein in its entirety.

### FIELD OF THE INVENTION

The invention relates to the field of catheter-based optical diagnostic probes and more specifically to fiber optic probes for performing high wavenumber Raman spectroscopy and spectral-domain optical coherence tomography (SD-OCT).

### BACKGROUND OF INVENTION

Catheter-based Raman spectroscopy has been previously proposed for the chemical analysis and diagnosis of vascular tissue including human atherosclerotic lesions. However, typical methods of collecting Raman scattered light from the surfaces of artery do not register information about the distance of the scattering element from the collection optics. Raman spectroscopy techniques that do incorporate optical methodologies for depth-sensing information have been too large or too impractical to be incorporated into intravascular catheters. One method previously explored by one of the inventors (Brennan) involved a combination IVUS/Raman catheter for intravascular diagnosis. These prior studies focused on using the Raman-scattered light in the Raman “fingerprint” region to supplement the IVUS data. The collection of Raman spectra in the fingerprint (FP) region, i.e., approximately 200 to 2,000 cm⁻¹, through optical fibers is complicated by Raman signal from the fibers themselves. In order to collect uncorrupted FP spectra, it has been necessary to incorporate complex optics and filters on the tips of catheters and often these designs require the use of multiple optical fibers. Since the Raman-scattered signal is weak, large multimode fibers are utilized in the multi-fiber catheter designs resulting in an unwieldy catheter that is generally incapable of exploring delicate arteries, such as the human coronary arteries.

U.S. Pat. No. 5,953,477 discloses methods and apparatuses for the manipulation and management of fiber optic light, and is incorporated by reference herein in its entirety.

U.S. Pat. No. 6,144,791 discloses the use of beam steering techniques in optical probes, and is incorporated by reference herein in its entirety.

U.S. Pat. No. 6,222,970 discloses methods and apparatuses for filtering optical fibers and applying filters to optical fibers, and is incorporated by reference herein in its entirety.

U.S. Pat. No. 6,445,939 discloses ultra-small optical probes, imaging optics and methods of using the same, and is incorporated by reference herein in its entirety.

U.S. Pat. No. 6,507,747 discloses optical imaging probes that include a spectroscopic imaging element and an optical coherence tomography imaging element, and is incorporated by reference herein in its entirety.

U.S. Pat. No. 6,904,199 discloses optical catheters that include a double clad optical fiber, and is incorporated by reference herein in its entirety.

U.S. Pat. No. 7,177,491 discloses optical fiber-based optical low coherence tomography, and is incorporated by reference herein in its entirety.

U.S. Pat. No. 7,190,464 discloses low coherence interferometry for the detection and characterization of atherosclerotic vascular tissue, and is incorporated by reference herein in its entirety.

U.S. Publication No. 2001/0047137 discloses the use of near-infrared spectroscopy for the characterization of vascular tissue and teaches against the use of Raman spectroscopy for such characterization, and is incorporated by reference herein in its entirety.

U.S. Publication No. 2004/0260182 discloses intraluminal spectroscope devices with wall-contacting probes, and is incorporated by reference herein in its entirety.

U.S. Publication No. 2005/0054934 discloses an optical catheter with dual-stage beam redirector, and is incorporated by reference herein in its entirety.

U.S. Publication No. 2006/0139633 discloses the use of high wavenumber Raman spectroscopy for the characterization of tissue, and is incorporated by reference herein in its entirety. Santos et al., Fiber-Optic Probes for In Vivo Raman Spectroscopy in the High-Wavenumber Region, Anal. Chem. 2005, 77, 6747-6752 discloses probe designs for high wavenumber Raman spectroscopy, and is incorporated by reference herein in its entirety.

U.S. Publication No. 2007/0076212 discloses catheter-based methods and apparatuses for analyzing vascular tissue that combine infrared spectroscopy for chemical analysis with optical coherence tomography, and is incorporated by reference herein in its entirety.

U.S. Publication No. 2004/0260182 discloses intraluminal spectroscope devices with wall-contacting probes, and is incorporated by reference herein in its entirety.

U.S. Publication No. 2005/0054934 discloses an optical catheter with dual-stage beam redirector, and is incorporated by reference herein in its entirety.

U.S. Publication No. 2006/0139633 discloses the use of high wavenumber Raman spectroscopy for evaluating tissue, and is incorporated by reference herein in its entirety.

In view of the above, what is needed is a optical fiber-based optical probe apparatus that enables catheter-based high-wavenumber Raman spectroscopy and spectral-domain optical coherence tomography and methods of diagnosing tissue using the same.

### SUMMARY OF INVENTION

The invention provides apparatuses, systems and methods for performing both high wavenumber Raman spectroscopy and spectral-domain optical coherence tomography, in order to obtain chemical composition information and depth/morphological information about the same tissue target.

The optical fibers may be configured for forward or lateral (side) viewing. For example, for lateral-viewing, the distal probe end of the fiber may be angled with respect to the central axis of the fiber to provide off-axis transmission of light and to receive off-axis light. As an alternative, the distal end of the fiber may be operably connected to (in optical communication with) a beam redirecting element such as a miniature prism or mirror face that directs light off-axis and receives off-axis light.

A fiber optic probe system can perform Raman spectroscopy and spectral domain optical coherence tomography over an optical fiber. An optical fiber has a proximal end, a distal probe end and a central longitudinal axis and comprising a core and at least one clad surrounding the core. A laser light source can be operably coupled or selectively operably coupleable to the proximal end of the optical fiber to transmit Raman excitation light down at least one of the core and the clad of the optical fiber. An interferometry light source can be operably coupled or selectively operably coupleable to the proximal end of the optical fiber to transmit light down the core of the optical fiber. An interferometer can be operably coupled or selectively operably coupleable to the proximal end of the optical fiber to receive phase-shifted light from a sample via the core of the fiber and combine the phase-shifted light with a reference beam. A Raman filter system can be operably coupled or selectively operably coupleable to the proximal end of the optical fiber to receive scattered light from a sample via the core of the fiber and reduce the intensity of the Raleigh shifted light while leaving most of the Raman shifted light. A spectrometer can be operably coupled or selectively operably coupleable to the proximal end of the optical fiber to receive scattered light from a sample via at least one of the Raman filter system and the interferometer system.

The optical fiber can be a single mode optical fiber or a double-clad optical fiber. The spectrometer can be configured to measure Raman scattered light in the range of 2,500-4,000 cm⁻¹. An optical switch or optical switches can be used to select between the Raman optical filter system or the interferometer system so that only one of these optical signals enters the spectrometer at any given moment. The optical paths of the Raman optical filter system and the interferometer system can be physically separated so that these signals can be measured simultaneously in the spectrometer. The system can be configured to simultaneously collect the Raman scattered light and the phase-shifted light. An optical switch or optical switches can couple light into the optical fiber by selecting between either the Raman excitation light source and Raman filter system or the interferometer light source and interferometer. The spectrometer preferably can be a single spectrometer. The spectrometer can be used to measure the high wave number of Raman shifted light. The spectrometer receives scattered light from a sample via either the Raman filter system or the interferometer system.

A basket catheter optical probe system can perform high wavenumber Raman spectroscopy and optical coherence tomography over optical fibers. An elongate basket catheter body can include a proximal end and a distal end, and at or near the distal end a basket section comprising wall-approaching probe arms. A double clad optical fiber can have a proximal end, a distal probe end and a central longitudinal axis and comprising a core, an inner clad surrounding the core and an outer clad surrounding the inner clad, the double clad fiber extending within the elongate basket catheter body, the distal probe end of the double clad fiber terminating within a wall approaching probe arm of the catheter. A laser light source can be operably coupled or selectively operably coupleable to the proximal end of the double clad fiber to transmit Raman excitation light down at least one of the core and the inner clad of the double clad fiber. An interferometry light source can be operably coupled or selectively operably coupleable to the proximal end of the double clad fiber to transmit light from the interferometry light source down the core of the double clad fiber. An interferometer can be operably coupled or selectively operably coupleable to the proximal end of the optical fiber to receive phase-shifted light from a sample via the core of the fiber and combine the phase-shifted light with a reference beam. A Raman filter system can be operably coupled or selectively operably coupleable to the proximal end of the optical fiber to receive scattered light from a sample via the core of the fiber and reduce the intensity of the Raleigh shifted light while leaving most of the Raman shifted light. An optical switch or optical switches can be to couple light into the optical fiber by selecting between either the Raman excitation light source and Raman filter system or the interferometer light source and interferometer. A spectrometer can be operably coupled or selectively operably coupleable to the proximal end of the optical fiber to receive scattered light from a sample via either the Raman filter system or the interferometer system. The double clad fiber can be a single fiber. The spectrometer can be a single spectrometer. The spectrometer can be configured to measure Raman scattered light in the range of 2,500-4,000 cm⁻¹. An optical switch or optical switches can be used to select between the Raman optical filter system or the interferometer system so that only one of these optical signals enters the spectrometer at any given moment. The optical paths of the Raman optical filter system and the interferometer system can be physically separated so that these signals can be measured simultaneously in the spectrometer. The system can be configured to simultaneously collect the Raman scattered light and the phase-shifted light.

A rotating catheter optical probe system can be capable of performing high wavenumber Raman spectroscopy and optical coherence tomography over an optical fiber. A double clad optical fiber can have a proximal end, a distal probe end and a central longitudinal axis and comprising a core, an inner clad surrounding the core and an outer clad surrounding the inner clad, said double clad fiber extending within the elongate catheter body, the distal probe end of the double clad fiber terminated to view off-axis of the optical fiber. A laser light source can be operably coupled or selectively operably coupleable to the proximal end of the double clad fiber to transmit Raman excitation light down at least one of the core and the inner clad of the double clad fiber. An interferometry light source can be operably coupled or selectively operably coupleable to the proximal end of the double clad fiber to transmit light from the interferometry light source down the core of the double clad fiber. An interferometer can be operably coupled or selectively operably coupleable to the proximal end of the optical fiber to receive phase-shifted light from a sample via the core of the fiber and combine the phase-shifted light with a reference beam. A Raman filter system can be operably coupled or selectively operably coupleable to the proximal end of the optical fiber to receive scattered light from a sample via the core of the fiber and reduce the intensity of the Raleigh shifted light while leaving most of the Raman shifted light. An optical switch or optical switches can couple light into the optical fiber by selecting between either the Raman excitation light source and Raman filter system or the interferometer light source and interferometer. A single spectrometer can be operably coupled or selectively operably coupleable to the proximal end of the optical fiber to receive scattered light from a sample via either the Raman filter system or the interferometer system. The spectrometer can be configured to measure Raman scattered light in the range of 2,500-4,000 cm⁻¹. An optical switch or optical switches can be used to select between the Raman optical filter system or the interferometer system so that only one of these optical signals enters the spectrometer at any given moment. The optical paths of the Raman optical filter system and the interferometer system can be physically separated so that these signals can be measured simultaneously in the spectrometer. The system can be configured to simultaneously collect the Raman scattered light and the phase-shifted light.

A method can be is provided for optically analyzing a blood vessel, by inserting into a blood vessel a double clad optical fiber having a proximal end, a distal probe end and a central longitudinal axis and comprising a core, an inner clad surrounding the core and an outer clad surrounding the inner clad; launching laser light into at least one of the core and the inner clad of the double clad fiber at its proximal end to illuminate a tissue region via the distal end of the double clad fiber, thereby generating a Raman spectra from the tissue region; receiving the Raman spectra via the inner clad of the fiber at the proximal end of the double clad fiber, and measuring the Raman spectra in the range 2,500-4,000 cm⁻¹ using a Raman spectrometer configured to measure said range; launching light from an interferometry light source into the core of the double clad fiber at its proximal end to illuminate the tissue region via the distal end of the double clad fiber, thereby producing a sample beam for interferometric analysis; receiving the sample beam via the core of the double clad fiber at its proximal end and performing interferometer by combining the sample beam with a reference beam using an interferometer, thereby obtaining both Raman spectroscopic data and interferometric data for the tissue region.

The interferometer can be a Michelson interferometer. The laser light source can emit light in the near-infrared wavelength range. The laser light source can emit light in the wavelength range of near-infrared visible light to 2 μm. The method can repeatedly switch between (i.) providing illumination from the laser light source and measuring the Raman spectra and (ii.) providing illumination from the interferometry light source and performing interferometry. The method can simultaneously receive Raman-scattered light and phase-shifted light from the tissue region.

A fiber optic probe system can be configured to simultaneously perform high wavenumber Raman spectroscopy and optical coherence tomography over an optical fiber. A double clad optical fiber can have a proximal end, a distal probe end and a central longitudinal axis and comprising a core, an inner clad surrounding the core and an outer clad surrounding the inner clad. A light source can be operably coupled to the proximal end of the double clad fiber to transmit Raman excitation light down at least one of the core and the inner clad of the double clad fiber to illuminate a sample with a wavelength range of light. A Raman spectrometer operably can be coupled to the proximal end of the double clad fiber to receive Raman scattered light from the sample via the inner clad of the fiber. An interferometer can be operably coupled the proximal end of the double clad fiber to receive phase-shifted light from the sample via the core of the fiber and combine the phase-shifted light with a reference beam. The spectrometer can be configured to measure Raman-scattered light in the range of 2,500-4,000 cm⁻¹. The interferometer can be a Michelson interferometer.

A method can be provided for optically analyzing a blood vessel by inserting into a blood vessel a double clad optical fiber having a proximal end, a distal probe end and a central longitudinal axis and comprising a core, an inner clad surrounding the core and an outer clad surrounding the inner clad; launching light having a wavelength range into at least one of the core and the inner clad of the double clad fiber at its proximal end to illuminate a tissue region via the distal end of the double clad fiber, thereby generating both Raman-scattered light from the tissue region and phase shifted light from the tissue region; receiving the Raman-scattered light via the inner clad of the fiber at the proximal end of the double clad fiber, and measuring the Raman-scattered light using a Raman spectrometer configured; receiving the phase-shifted light via the core of the double clad fiber at its proximal end and performing interferometry by combining the phase-shifted with a reference beam using an interferometer, thereby obtaining both Raman spectroscopic data and interferometric data for the tissue region. The Raman spectrometer can be configured to measure Raman scattered light in the range of 2,500-4,000 cm⁻¹. The interferometer can be a Michelson interferometer. The method can simultaneously receive Raman-scattered light and phase-shifted light from the tissue region.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

FIG. 1 shows a typical prior art optical setup of SD-OCT.

FIG. 2 illustrates a typical prior art Raman spectroscopy apparatus.

FIG. 3 illustrates an apparatus/system embodiment of the invention that combines SD-OCT and high wavenumber Raman spectroscopy.

FIG. 4 shows a basket catheter configuration that may be employed according to the invention.

### DETAILED DESCRIPTION

The present invention provides single optical fiber-based optical probe designs that enable catheter-based Raman spectroscopy and optical coherence tomography and methods of diagnosing tissue using the same. Accordingly, the apparatuses and methods of the invention advantageously facilitate the collection of chemical composition information along with depth and/or morphological information.

### Spectral Domain OCT (SD-OCT)

In spectral domain OCT, the broadband interference is acquired with spectrally separated detectors (e.g., by encoding the optical frequency in time with a spectrally scanning source or with a dispersive detector, like a grating and a linear detector array). Due to the relationship between the auto correlation and the spectral power density, the depth scan can be immediately calculated by a Fourier-transform from the acquired spectra, without movement of the reference arm. This feature improves imaging speed dramatically, while the reduced losses during a single scan improve the signal to noise proportional to the number of detection elements. The parallel detection at multiple wavelength ranges limits the scanning range, while the full spectral bandwidth sets the axial resolution.

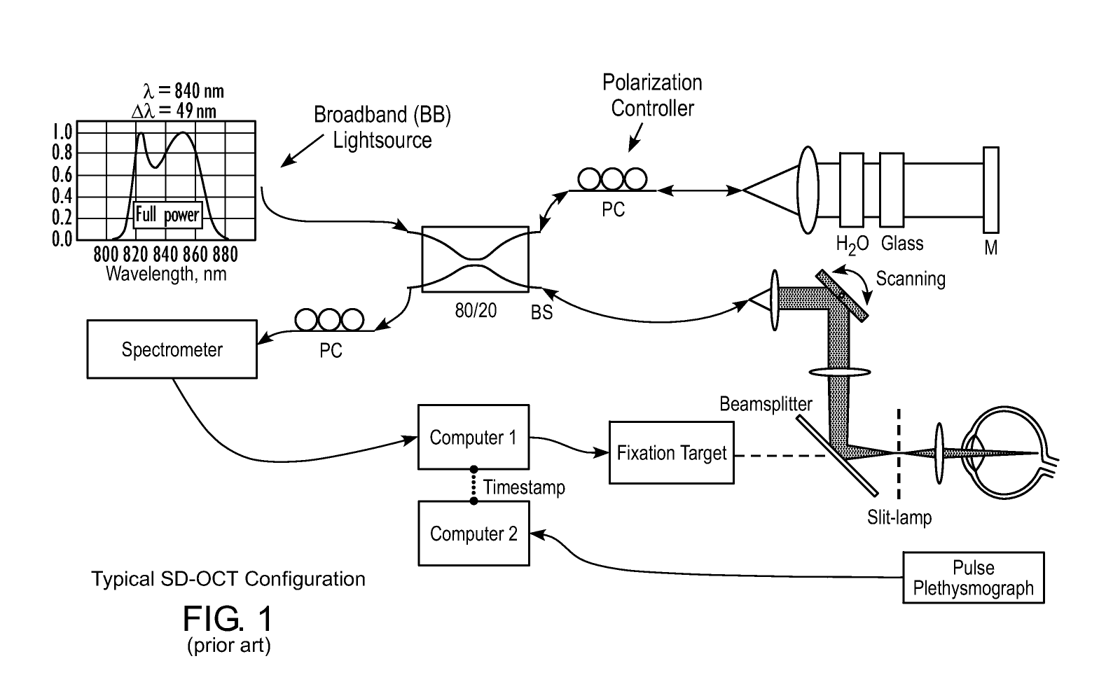

FIG. 1 illustrates a typical set-up for SD-OCT.

### High Wavenumber Raman Spectroscopy

One aspect of the invention utilizes Raman scattered light shifted outside of the fingerprint region to conduct tissue analysis, in the high wavenumber (HW) region, i.e., in the range of approximately 2,500-4,000 cm⁻¹, for example, in the range 2,500-3,700 cm⁻¹ or in the range of 2,600 to 3,200 cm⁻¹, and combines this information with OCT data to provide chemical compositional information as a function of depth in a lumen wall, such as a blood vessel wall, such as an artery wall.

Since cholesterol and its esters have distinctive Raman scattering profiles within the Raman high wavenumber region, the use of the Raman high wavenumber region for analysis is particularly useful for locating and characterizing lipid-rich deposits or lesions as may occur in blood vessels, such as atherosclerotic plaques prone to rupture (e.g., so-called vulnerable plaques) in arteries, such as the coronary arteries. Thus, in one aspect the invention provides methods for locating and/or characterizing lipid-rich depositions and/or lesions, such as vulnerable plaques, in blood vessel walls such as in arteries, by integrating Raman high wavenumber spectral data to indicate chemical composition and regional depth information from IVUS and/or other depth-sensing capable technology, as described herein.

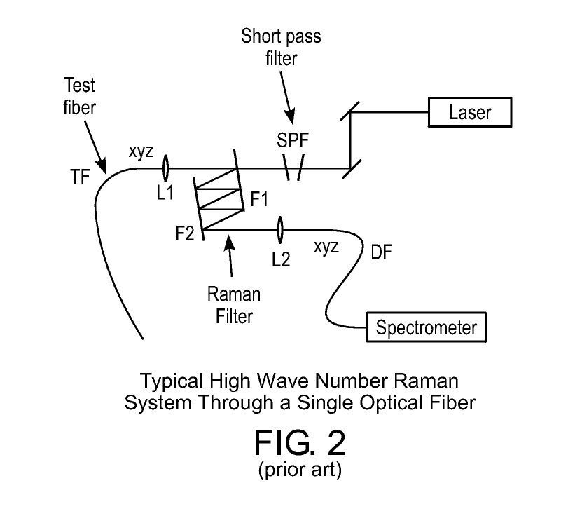

FIG. 2 shows a typical high wavenumber (HW) Raman spectroscopy apparatus.

### Implementation of the HW Raman & SD-OCT Combination System

The laser source(s) for HW Raman may be of any suitable kind for the Raman excitation. Excitation light for the HW Raman catheter system may be generated by a semiconductor laser and routed into the catheter fiber(s). Any suitable laser source(s) may be used including without limitation diode-pumped solid state lasers (DPSS). Volume Bragg Grating (VBG) stabilized multi-mode laser diode sources, such as those available from PD-LD, Inc. (Pennington, NJ) may also be used. The laser source used may be a single mode laser or a multi-mode laser, such as those known in the art. Before being launched into the catheter optical fiber(s), the light may be routed through an optical bandpass filter to provide a spectrally pure excitation source, i.e., without unwanted spectral features that may interfere with the Raman shifted light or that may produce additional unwanted spectral signatures. The light may also be passed through a chromatic beam splitter, where the excitation light is routed into the fiber and then the return light, which has been shifted in wavelength, is routed along another optical path. The laser emission wavelength used for HW Raman spectroscopy may, for example, be in the near-infrared range, be in the range of near-infrared to 2 μm, or be in the range of near-infrared to 1 μm.

Raman excitation light will be launched into and guided by the optical fiber to the region of interest in an artery, Raman-scattered light will be collected at the catheter tip, and the return light will be guided down mostly the outer core of the fiber, but collected light may also reside in the inner core. The returning Rayleigh scattered light, which is at the same wavelength as the excitation wavelength, will preferably be removed from the return beam before it enters the/a spectrometer, which may be accomplished using an optical long-pass filter. The light will then be dispersed chromatically in the spectrometer onto a detection array.

The interferometry light source for spectral domain OCT (SD-OCT) will be different and may be a frequency-swept single-mode laser and/or broadband LED light source.

If the two measurements (HW Raman and OCT) are separated temporally, optical switches may be utilized to cycle between the excitation sources and the return beam paths to accomplish both objectives, i.e., obtain Raman and OCT measurements with the same catheter. A rapid acquisition speed allows both navigation and identification information to be obtained about the same location in the artery. In one implementation, a switching speed faster than, for example, 100 milliseconds provides a sufficient data acquisition speed for most applications, although other switching time ranges are acceptable. The optical switches used in various embodiments of the invention may be of any suitable kind For example, bulk optical approaches such as electrical relay-controlled prisms may be used. Acousto-optical switches may be used and permit nano-second scale switching speeds, Acousto-optical switching is disclosed, for example in U.S. Pat. No. 6,922,498. Micro-electromechanical system-based (MEMS) optical switches may also be used, such as those involving the positioning of micro-mirrors and are disclosed, for example, in U.S. Pat. No 6,396,976. Bubble-based optical switching mechanisms that involve the intersection of two waveguides so that light is deflected from one to the other when an inkjet-like bubble is created may also be used and are disclosed, for example, in U.S. Pat. No. 6,212,308. Electro-optical switches of various types may also be used. One type of electro-optical switch employs the electro-optical effect of some materials in which the index of refraction changes under the influence of an applied electrical field. Such materials include lithium niobate, electro-optical ceramics, polymers and other nonlinear optical and semiconductor materials. The materials may be incorporated into an arm of an interferometer to control the propagation direction of light. Fast switching times can be obtained with electro-optical switches, on the order of nanoseconds for lithium niobate. Operation and coordination of the various switches of embodiments of the invention and for the various modes of operation thereof may be under the control of one or more microprocessors and/or control circuits.

The suitable range of excitation wavelength with respect to the Raman spectroscopy aspect of the invention may, for example, be selected so that Raman-shifted light within an area of interest falls within the detection range of the detector device, such as a silicon CCD for wavelengths <˜1 micrometer or, for example, an InGaAs detector array or infrared focal plane array detectors for longer wavelengths in the infrared, that is used to measure the Raman shifted light. In one embodiment, the excitation light wavelength range may be within the wavelength range of long-wavelength visible light to at or about 2 micron. In one embodiment, the excitation light wavelength range may be within the wavelength range of long-wavelength visible light to at or about 1 micron.

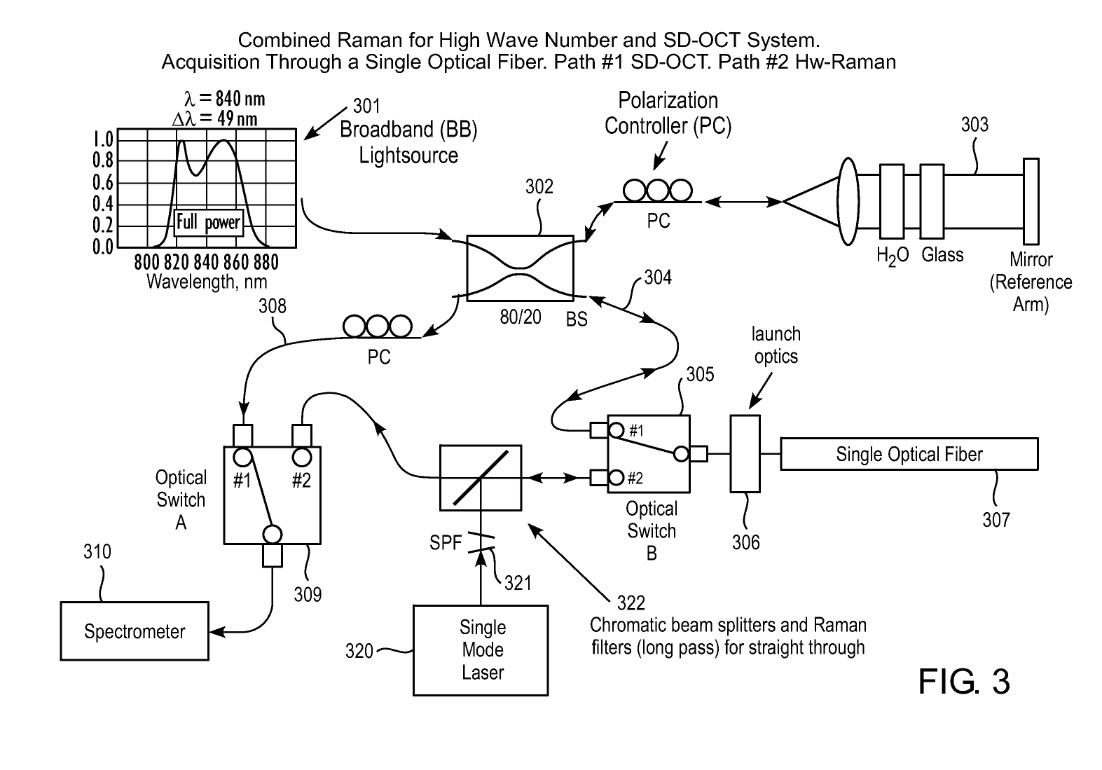

FIG. 3 shows an apparatus embodiment of the invention that combines HW Raman spectroscopy and SD-OCT into a single system. Path #1 is SD-OCT. Path #2 is HW Raman. Element 301 is the broadband light source for SD-OCT. 302 is a beam splitter that splits out light from source 301 to reference arm 303 and path 304 through switch 305 (toggled to its path #1) through launch optics 306 and optical fiber 307 which directs light to a sample and returns light collected from the sample. Preferably, this occurs through a single fiber. Light collected from the sample after illumination with the light from light source 301 returns back through fiber 307 and optics 306 and through path #1 of switch 305, back through path 304, passing through beam splitter 302, then path 308 to switch 309 (toggled to its path #1) and then spectrometer 310. Thus, it can be seen that the light directed to and reflected back from the reference arm 303 and light collected from the sample after illumination with the broadband light recombine in the same path so that they may interfere before detection by spectrometer 310. For HW Raman spectroscopy, each of switches 305 and 309 are toggled to their #2 paths. A Raman spectroscopy light source such as a single mode laser 320 is provided. A short pass filter 321 may be provided to ensure that a narrow band of laser light is transmitted to dichroic mirror (beam splitter) 322 which reflects light from laser 320 toward and into optical switch 305 (set on path #2), from which the light then passes into launch optics 306 and the optical fiber 307 where the light is directed to a target. Wavenumber shifted light collected from the sample is directed back down optical fiber 307, through optics 306 into optical switch 305 (set on path #2) back toward dichroic mirror 322. Dichroic mirror 322 is selected so that it reflects the excitation wavelength of laser light from laser source 320 but passes wavelengths of light corresponding to the range of interest of wavenumber-shifted light for analysis. Thus, wavenumber-shifted light in the range of interest passes through dichroic mirror 322 into switch 309 (set to path #2) and thereafter into spectrometer 310 for analysis. The optical paths between components of the apparatus may be open or consist of optical fibers or be a combination of both configurations. Generally, the apparatus will also have at least one controller that controls switches 305 and 309. Switches 305 and 309 may be high-speed switches. Switches 305 and 309 may be toggled rapidly in a coordinated manner (i.e., between both on path #1 or both on path #2) so that for essentially each position of a target sampled, both HW-Raman data and SD-OCT are collected. In another embodiment of the invention, optical switch 309 may be eliminated from the system by physically separating in the spectrometer the optical path of the received Raman scattered light and the SD-OCT interferometer light, so they do not physically overlap, allowing for simultaneous measurement of both signals, e.g. the Raman spectrum can be projected by the spectrometer optics onto the detector array beside the SD-OCT received spectrum.

Switch 309 is optional and the system of FIG. 3 can be implemented without the use of switch 309.

The apparatus of the present invention greatly reduces the space required over previous systems as well as the costs for implementing both HW Raman spectroscopy and SD-OCT in a single system, since the same spectrometer and detector are used for both techniques. Further advantageously, the same probe optical fiber(s), for example, in catheter embodiments, are used to perform both optical techniques.

A double clad optical fiber may also be used so that the HW Raman spectroscopy and SD-OCT therewith in the manner of co-owned U.S. application serial no. 2008/0304074, which is incorporated by reference herein in its entirety.

In still another variation of the invention, a multi-channel modular system is provided in which multiple probe optical fibers are connected to parallel intermediary optical modules that are connected to the same spectrometer so that the signal from each fiber (channel) is spatially segregated within the spectrometer, thus permitting each channel to be analyzed simultaneously using the same spectrometer in the manner of U.S. application serial no. 2009/0231578, which is incorporated by reference herein in its entirety.

The system of the invention may be employed with any kind of optical catheter probe of the invention, such as an intravascular catheter having lumen wall-approaching (or contacting) probes. For example, in a basket catheter having 2, 3, 4, 5, 6, or more probe arms (basket splines) one or more or all of the arms may have an optical fiber probe terminate in or near the wall-contacting portion of a probe arm and which are oriented so that their field-of-view looks radially outward (toward the wall of the vessel or lumen). Basket type catheter designs as well as other types of catheter designs having wall-contacting probes that may be readily adapted to the present invention include, for example, those disclosed in U.S. Publication No. 2004/0260182, which is incorporated herein by reference.

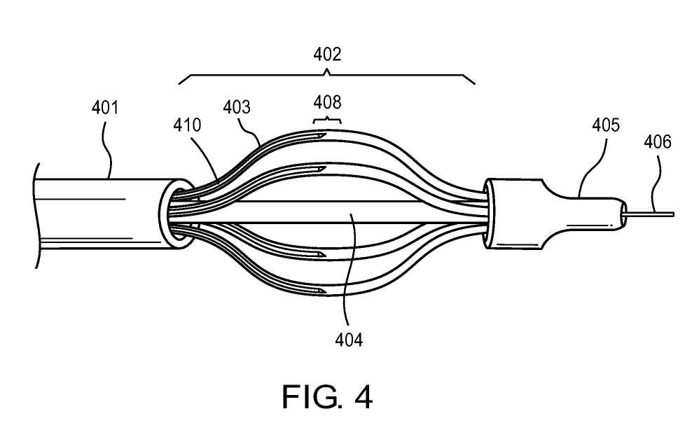

FIG. 4 shows a basket-style side-viewing optical catheter embodiment of the invention that has a proximal outer shaft 401, a basket section 402 including four probe arms 403 each including one or more side viewing optical fibers 410 (or side-viewing optical assemblies of a fiber and a beam redirecting element), that terminate in or around the apex of the radially extended probe arm (side-viewing portion 408 of the basket section) in order to contact or near a vessel wall so that Raman spectroscopic and interferometric evaluations of a lumen wall, such as a blood vessel wall, can be performed. The catheter also includes a distal tip 405 that is connected to a guidewire tube 404, so that the catheter may travel over a guidewire 406, and to the distal end of each probe arm. The viewing portion of the probe arms may have a window to permit direct viewing by the side-viewing portions of the optical fiber (or the optical assembly of a fiber and a beam redirecting element). Radial expansion and contraction of the probe arms of the basket section may be accomplished by contracting and extending the opposite ends of the probe arms, respectively. The guidewire tube, which is attached to the distal tip of the catheter, may for example, be slideable within the catheter thereby permitting said contracting and extending of the opposite ends of the probe with respect to each other, while the proximal ends of the probe arms remain fixed with respect to the proximal outer shaft. Alternatively, for example, a slideable sheath may be provided to control the radial extension of the basket section. Optional radiopaque marker bands may also be provided to aid in visualizing the catheter within a blood vessel. The basket catheter may, for example, be an intravascular catheter sized for use in human coronary and/or carotid arteries.

The invention also provides side-viewing probe embodiments in which the probe fiber itself or a shaft including the probe fiber(s) of the invention rotates to provide a radial scan or in which a beam redirecting element (such a mirror or prism) in optical communication with the probe fiber of the invention rotates to provide radial scanning Rotational mechanisms for obtaining radial scans are well known in the art, such as U.S. Pat. Nos. 6,445,939, 6,891,984, and 7,241,286, and US Patent Applications US 2007/0161893 and US 2007/0239032, the disclosures of which are incorporated herein by reference. Accordingly, one embodiment of the invention provides a catheter, such as an intravascular catheter, which may be sized for use in the human coronary and/or carotid arteries, that includes a side-viewing optical fiber (or side-viewing assembly of a fiber and beam redirecting element) according to the invention, wherein the catheter is configured to provide rotation of the fiber in order to provide radial scanning or is configured to rotate a beam redirecting element (such a mirror or prism) in optical communication with the probe fiber of the invention rotates to provide radial scanning

Front-looking or at least partially front-looking optical fiber probes are also provided by and within the scope of the invention. In this case, the distal tip of the double clad optical fiber will not be angled to provide lateral viewing. The front-viewing configuration is well suited to intravascular catheter designs in which the distal end of an elongate wall-contacting probe is extended from the side of the catheter to contact a tissue target in a “head-on” manner.

A related embodiment of the invention provides a method for optically analyzing a blood vessel that includes the steps of: inserting into a blood vessel a double clad optical fiber having a proximal end, a distal probe end and a central longitudinal axis and comprising a core, an inner clad surrounding the core and an outer clad surrounding the inner clad, the distal probe end of the fiber being angled to provide off-axis transmission and receipt of light; launching laser light into the core and/or inner clad of the double clad fiber at its proximal end to illuminate a tissue region via the distal end of the double clad fiber, thereby generating a Raman spectra from the tissue region; receiving the Raman spectra via the inner clad of the fiber at the proximal end of the double clad fiber, and measuring the Raman spectra in the range 2,500-4,000 cm⁻¹ using a Raman spectrometer configured to measure said range; launching light from an interferometry light source into the core of the double clad fiber at its proximal end to illuminate the tissue region via the distal end of the double clad fiber, thereby producing a sample beam for interferometric analysis; receiving the sample beam via the core of the double clad fiber at its proximal end and performing interferometry by combining the sample beam with a reference beam using an interferometer, thereby obtaining both Raman spectroscopic data and interferometric data for the tissue region.

The method may, for example, include repeatedly switching between (i.) providing illumination from the laser light source and measuring the Raman spectra and (ii.) providing illumination from the interferometry light source and performing interferometry. Still further, the method may include the step of longitudinally displacing the distal probe end in a blood vessel, such as an artery, while rapidly performing the switching between the two optical interrogation modalities. Where the double clad fiber probe is presented within a catheter such as an intravascular catheter, a mechanical pullback mechanism may be used to perform said longitudinal displacement. The method may also include a step of disposing the distal probe end of the double clad fiber to contact or be in close proximity to the tissue region target in any suitable manner.

In any of the above embodiments, the interferometer may, for example, be a Michelson interferometer. In any of the above embodiments, the laser light source may emit (or the laser light may be emitted) at a wavelength at or about 671 nm for performing the HW Raman spectroscopy, such as a Model RCL-100-671 100 mW, 671 nm, TEMoo, DPSS, CW laser with power supply from CrystaLaser (Reno, Nev., USA). In any of the above embodiments, measurement may, for example, optionally be restricted to an even narrower region within the HW Raman region such as for example, the range of 2,500-3,700 cm⁻¹ or the range of 2,600 to 3,200 cm⁻¹. Any of the systems of the invention may further include at least one microprocessor and/or control circuitry to control the operation of the components of the system and/or to analyze the data obtained using the systems. Generally, the at least one microprocessor may be provided with computer accessible memory and computer instructions directing the processor to carry out various operations.

Each of the patents and other publications cited in this disclosure is incorporated by reference in its entirety.

While certain embodiments of the invention are exemplified herein with respect to the optical analysis of tissue, it should be understood that the optical fibers, probe embodiments and systems (apparatuses) of the invention are not limited to use in particular applications or types of samples, except as may be explicitly indicated herein.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A fiber optic probe system capable of performing Raman spectroscopy and spectral domain optical coherence tomography over an optical fiber, comprising:
an optical fiber having a proximal end, a distal probe end and a central longitudinal axis and comprising a core and at least one clad surrounding the core;
a laser light source operably coupled or selectively operably coupleable to the proximal end of the optical fiber to transmit Raman excitation light down at least one of the core and the clad of the optical fiber;
an interferometry light source operably coupled or selectively operably coupleable to the proximal end of the optical fiber to transmit light down the core of the optical fiber;
an interferometer operably coupled or selectively operably coupleable to the proximal end of the optical fiber to receive phase-shifted light from a sample via the core of the fiber and combine the phase-shifted light with a reference beam;
a Raman filter system operably coupled or selectively operably coupleable to the proximal end of the optical fiber to receive scattered light from a sample via the core of the fiber and reduce the intensity of the Raleigh shifted light while leaving most of the Raman shifted light; and
a spectrometer operably coupled or selectively operably coupleable to the proximal end of the optical fiber to receive scattered light from a sample via at least one of the Raman filter system and the interferometer system.

2. The system of claim 1, wherein the optical fiber is a single mode optical fiber.

3. The system of claim 1, wherein the optical fiber is a double-clad optical fiber.

4. The system of claim 1, wherein the spectrometer is configured to measure Raman scattered light in the range of 2,500-4,000 cm⁻¹.

5. The system of claim 1, wherein an optical switch or optical switches are used to select between the Raman optical filter system or the interferometer system so that only one of these optical signals enters the spectrometer at any given moment.

6. The system of claim 1, wherein the optical paths of the Raman optical filter system and the interferometer system are physically separated so that these signals can be measured simultaneously in the spectrometer.

7. The system of claim 1, wherein the system is configured to simultaneously collect the Raman scattered light and the phase-shifted light.

8. The system of claim 1, further comprising:
an optical switch or optical switches to couple light into the optical fiber by selecting between either the Raman excitation light source and Raman filter system or the interferometer light source and interferometer.

9. The system of claim 1, wherein the spectrometer is a single spectrometer.

10. The system of claim 1, wherein the spectrometer is to measure the high wave number of Raman shifted light.

11. The system of claim 1, wherein the spectrometer receives scattered light from a sample via either the Raman filter system or the interferometer system.

12. A basket catheter optical probe system capable of performing high wavenumber Raman spectroscopy and optical coherence tomography over optical fibers:
an elongate basket catheter body comprising a proximal end and a distal end, and at or near the distal end a basket section comprising wall-approaching probe arms;
a double clad optical fiber having a proximal end, a distal probe end and a central longitudinal axis and comprising a core, an inner clad surrounding the core and an outer clad surrounding the inner clad, said double clad fiber extending within the elongate basket catheter body, the distal probe end of the double clad fiber terminating within a wall approaching probe arm of the catheter;
a laser light source operably coupled or selectively operably coupleable to the proximal end of the double clad fiber to transmit Raman excitation light down at least one of the core and the inner clad of the double clad fiber;
an interferometry light source operably coupled or selectively operably coupleable to the proximal end of the double clad fiber to transmit light from the interferometry light source down the core of the double clad fiber;
an interferometer operably coupled or selectively operably coupleable to the proximal end of the optical fiber to receive phase-shifted light from a sample via the core of the fiber and combine the phase-shifted light with a reference beam;
a Raman filter system operably coupled or selectively operably coupleable to the proximal end of the optical fiber to receive scattered light from a sample via the core of the fiber and reduce the intensity of the Raleigh shifted light while leaving most of the Raman shifted light;
an optical switch or optical switches to couple light into the optical fiber by selecting between either the Raman excitation light source and Raman filter system or the interferometer light source and interferometer; and
a spectrometer operably coupled or selectively operably coupleable to the proximal end of the optical fiber to receive scattered light from a sample via either the Raman filter system or the interferometer system.

13. The system of claim 12, wherein the double clad fiber is a single fiber.

14. The system of claim 12, wherein the spectrometer is a single spectrometer.

15. The system of claim 12, wherein the spectrometer is configured to measure Raman scattered light in the range of 2,500-4,000 cm⁻¹.

16. The system of claim 12, wherein an optical switch or optical switches are used to select between the Raman optical filter system or the interferometer system so that only one of these optical signals enters the spectrometer at any given moment.

17. The system of claim 12, wherein the optical paths of the Raman optical filter system and the interferometer system are physically separated so that these signals can be measured simultaneously in the spectrometer.

18. The system of claim 12, wherein the system is configured to simultaneously collect the Raman scattered light and the phase-shifted light.

19. A rotating catheter optical probe system capable of performing high wavenumber Raman spectroscopy and optical coherence tomography over an optical fiber:
a double clad optical fiber having a proximal end, a distal probe end and a central longitudinal axis and comprising a core, an inner clad surrounding the core and an outer clad surrounding the inner clad, said double clad fiber extending within the elongate catheter body, the distal probe end of the double clad fiber terminated to view off-axis of the optical fiber;
a laser light source operably coupled or selectively operably coupleable to the proximal end of the double clad fiber to transmit Raman excitation light down at least one of the core and the inner clad of the double clad fiber;
an interferometry light source operably coupled or selectively operably coupleable to the proximal end of the double clad fiber to transmit light from the interferometry light source down the core of the double clad fiber;
an interferometer operably coupled or selectively operably coupleable to the proximal end of the optical fiber to receive phase-shifted light from a sample via the core of the fiber and combine the phase-shifted light with a reference beam;
a Raman filter system operably coupled or selectively operably coupleable to the proximal end of the optical fiber to receive scattered light from a sample via the core of the fiber and reduce the intensity of the Raleigh shifted light while leaving most of the Raman shifted light;
an optical switch or optical switches to couple light into the optical fiber by selecting between either the Raman excitation light source and Raman filter system or the interferometer light source and interferometer; and
a single spectrometer operably coupled or selectively operably coupleable to the proximal end of the optical fiber to receive scattered light from a sample via either the Raman filter system or the interferometer system.

20. The system of claim 19, wherein the spectrometer is configured to measure Raman scattered light in the range of 2,500-4,000 cm⁻¹.

21. The system of claim 19, wherein an optical switch or optical switches are used to select between the Raman optical filter system or the interferometer system so that only one of these optical signals enters the spectrometer at any given moment.

22. The system of claim 19, wherein the optical paths of the Raman optical filter system and the interferometer system are physically separated so that these signals can be measured simultaneously in the spectrometer.

23. The system of claim 19, wherein the system is configured to simultaneously collect the Raman scattered light and the phase-shifted light.
